(19) United States
(12) Patent Application Publication
(10) Pub. No.: US 2020/0242942 A1
(43) Pub. Date: Jul. 30, 2020

(54) TRAFFIC LANE ENCROACHMENT INDICATOR SYSTEM

(71) Applicant: Daniel A. Gilbert, Arden, NC (US)

(72) Inventor: Daniel A. Gilbert, Arden, NC (US)

(21) Appl. No.: 16/775,586

(22) Filed: Jan. 29, 2020

Related U.S. Application Data
(60) Provisional application No. 62/798,897, filed on Jan. 30, 2019.

(51) Int. Cl. G08G 1/16; G08G 1/01; B60Q 9/00; G08G 1/052

(52) U.S. Cl. CPC G08G 1/167; G08G 1/0125; G08G 1/052; G08G 1/166; B60Q 9/008; G08G 1/0112

(57) ABSTRACT

The present invention offers a system for guiding drivers of vehicles going in the same direction to avoid encroaching each other's braking space. Encroachment may occur when a proximate vehicle merges too closely to a host vehicle or when the speed of a host vehicle and/or a proximate vehicle changes such that there is insufficient distance between the two vehicles, creating a hazard zone. The indicator system shall be mounted on a host vehicle and incorporate a gauge for determining the host vehicle's speed, one or more sensors to detect the relative proximity and speed of a proximate vehicle, a visual proximity indicator, and a controller for determining whether the proximate vehicle is too close to the host vehicle and operating the visual proximity indicator to signal the proximate vehicle it is within the hazard zone.

### FIELD OF THE INVENTION

This invention relates to a vehicle proximity indicator system to provide for safer traffic conditions on multi-lane roads by indicating when a proximate vehicle is within the hazard zone of the host vehicle.

### BACKGROUND OF THE INVENTION

A substantial number of motor vehicle accidents are caused when vehicles traveling the same direction on a multi-lane road become too close to each other due to differences in speed. Some accidents occur during passing maneuvers. In these instances, a vehicle passing a slower vehicle merges into the same lane as the passed vehicle and then slows down, requiring the passed vehicle to slow to avoid an accident. At times, the passed vehicle is not able to slow down to avoid an impact With the proximate vehicle as the proximate vehicle did not allow adequate distance for the passed vehicle to slow down or stop. Other accidents occur when a first vehicle is followed too closely by a second vehicle in the same lane in view of the speed, road conditions, and braking characteristics of the second vehicle.

This is an especially large concern when passenger vehicles pass weighted vehicles (e.g., semi-trailer truck; dump truck; recreational vehicle; vehicles towing trailers, recreational vehicles, campers, or boats) or when a weighted vehicle is following a passenger vehicle too close for existing road, speed, and vehicle conditions. There is a hazard zone in front of every vehicle in the direction it is moving within which there is danger of an impact should a proximate vehicle enter that zone and decrease its speed. Almost all drivers are unaware of the braking and stopping distance required for weighted vehicles. For example, the stopping distance of a 3,000 to 4,000 pound car going 65 miles an hour is roughly 316 feet. The stopping distance, or hazard zone, for a semi-trailer truck, which can weigh up to 80,000 pounds, traveling at 65 mph is 525 feet. Too often a passenger vehicle will pass a truck in one lane, change lanes in front of the truck, and decrease its speed. When the passenger vehicle slows, the truck operator must then apply the truck's brakes to avoid hitting the passenger vehicle. if the passenger vehicle has not avoided the hazard zone to allow for the minimum safe distance between it and the truck for the truck to safely reduce speed, the truck operator would be forced to choose between a rear-end collision or swerving off road or into another lane. This same dangerous situation occurs when a weighted vehicle is following another vehicle too closely for the relative speed, road conditions, and braking characteristics of the following vehicle.

While many passenger vehicles are outfitted with proximity sensors and alarms, such alarms generally are not triggered until a collision is imminent, giving the passenger vehicle no real opportunity to avoid the collision. This is particularly true since the passenger vehicle would have no information regarding the braking and stopping distance required by a weighted vehicle. Such sensors and alarms are primarily designed to avoid hitting a vehicle in front of a passenger vehicle outfitted with such a sensor. The inventive system is designed to educate drivers of all vehicles of the hazard zone in front of moving vehicles to encourage drivers to allow sufficient stopping distances between vehicles. The system described herein will reduce these rear-end collisions by providing an indicator on the weighted vehicle to notify the proximate vehicle of the danger of entering the hazard zone of the weighted vehicle.

### SUMMARY OF THE INVENTION

The invention has been made to address the above problems while making use of existing technology that has not yet been combined in this particular manner. One objective of this invention is to provide a method for a first vehicle to automatically signal a second proximate vehicle that the second vehicle is within the hazard zone of the first vehicle. Further objects of the invention involve considering the load carried by the first vehicle, road conditions, relative speed, weather conditions, and any other factors that may impact the first vehicle's ability to safely come to a stop without a collision.

To meet these objectives, the invention provides a traffic lane encroachment indicator system to assist proximate vehicles to avoid the hazard zone of a host vehicle on multi-lane roads. The system's indicator is located on a host vehicle in such a location that it is easily visible to the driver of a proximate vehicle that is in front of the host vehicle or intends to change lanes to proceed in front of the host vehicle. The indicator has at least one signal to indicate that the proximate vehicle is too close to safely change lanes or is otherwise within the host vehicle's hazard zone. The system uses a means for determining location data, such as the speed, of the host vehicle. The system also incorporates a sensor on the host vehicle used to detect the proximity of a proximate vehicle. A controller calculates the host vehicle's hazard zone and an acceptable distance for the proximate vehicle to proceed as compared to the host vehicle, determines the distance between the host vehicle and proximate vehicle, and controls the signal in the indicator to direct the proximate vehicle as to whether it is too close to the host vehicle.

### BRIEF DESCRIPTION OF THE DRAWINGS

FIG. 1 depicts a diagram showing the order of actions for the controller.

FIG. 2 depicts an embodiment of an alert panel containing a light array and two proximity sensors.

FIG. 3 depicts a front view of a semi-trailer truck bearing an embodiment of the system.

FIG. 4 depicts a top view of a semi-trailer truck and a proximate vehicle changing lanes too closely to the truck.

FIG. 5 depicts a semi-trailer truck bearing an embodiment of the traffic lane encroachment indicator system in which the alert panel of the indicator system is visible to a proximate vehicle and warns that the proximate vehicle is too close to the truck to change lanes.

FIG. 6 depicts the sideview mirror of a proximate vehicle that is within the hazard zone of a semi-trailer truck hearing an embodiment of the traffic lane encroachment indicator system.

FIG. 7 depicts an embodiment of an alert panel as would be seen by a proximate vehicle is within the hazard zone of a semi-trailer truck bearing an embodiment of the traffic lane encroachment indicator system.

FIG. 8 depicts a semi-trailer truck bearing an embodiment of the traffic lane encroachment indicator system in which a proximate vehicle refrains from changing lanes too closely to the truck.

FIG. 9 depicts the sideview mirror of a proximate vehicle that has safely passed the hazard zone of the host vehicle.

FIG. 10 depicts an embodiment of an alert panel as would be seen by a proximate vehicle that has safely passed the hazard zone of the host vehicle.

### DETAILED DESCRIPTION OF THE DRAWINGS

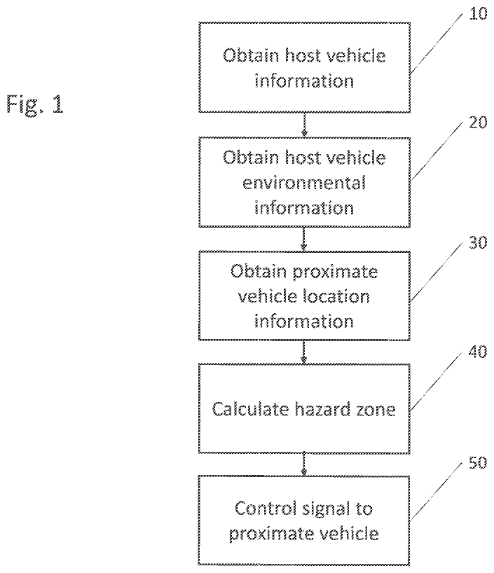

The construction and operation of an embodiment of the present invention are described in detail with references to the attached drawings, FIGS. 1-10.

The traffic lane encroachment indicator system is managed by a controller (not shown). The controller comprises an electronic device attached to a host vehicle 105 with logic software and hardware capable of making calculations based on information gathered from at least two sources and controlling at least one signal device. The controller may obtain electricity to operate directly from the host vehicle 105 or from a separate power source, such as a replaceable battery or solar panel charging system.

The controller further comprises a means for determining the speed of the host vehicle 105, or speed gauge. This speed gauge may be a Global Positioning System (GPS) or direct connection to the speedometer of the host vehicle 105. A smartphone in connection with the controller may also provide information regarding the speed of the host vehicle 105 and other environmental information.

The controller additionally comprises at least one proximity sensor 104 located on the exterior of the host vehicle 105. The embodiment shown also incorporates a second proximity sensor 106. Such proximity sensors 104, 106 will utilize a camera, radar, lidar, ultrasound, or some other technology or combination thereof to determine the distance between the host vehicle 105 and a proximate vehicle 107 and the vehicles' speeds as relative to each other.

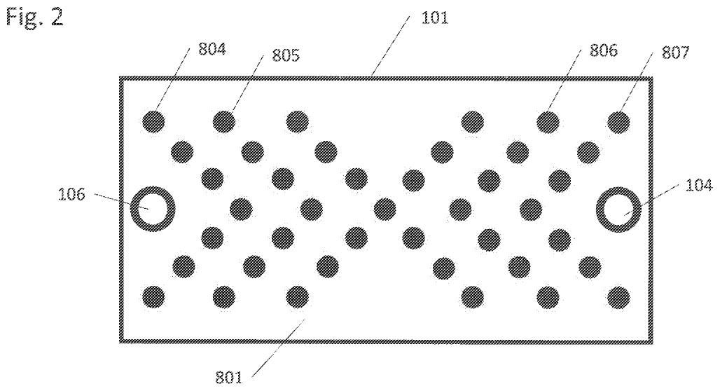

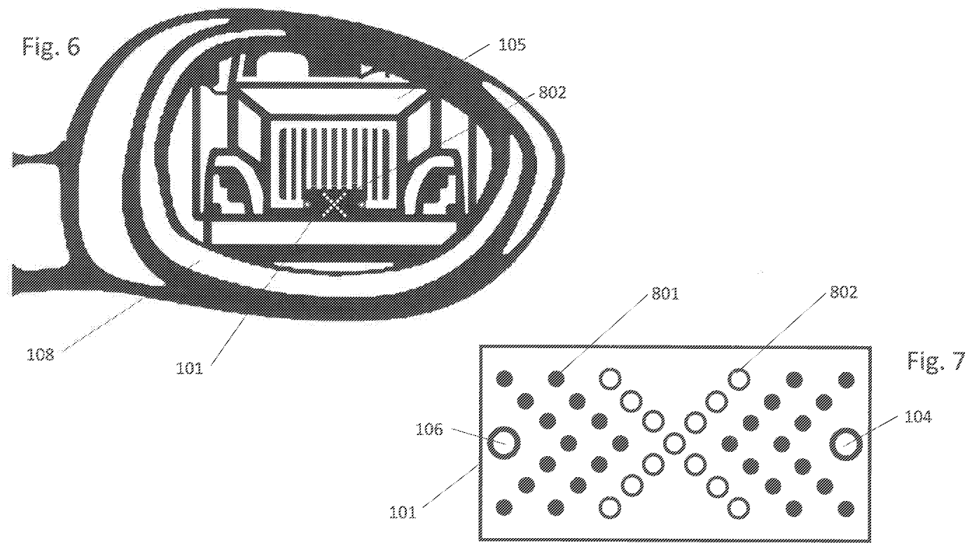

The controller further comprises an alert panel 101 containing a light array 801 located on the exterior of the host vehicle 105. The light array 801 contains at least one light that may be turned on, off, or in a flashing pattern by the controller as appropriate to signal the proximate vehicle 105. The alert panel 101 embodiment depicted herein contains a light array 801 comprising a plurality of lights arranged in a pattern. As shown in FIGS. 6-7, the light array 801 contains lights that, when illuminated, show a warning pattern 802, which is a set of lights forming an X shape in the center of the light array 801. As depicted in FIG. 2, the light array 801 further contains additional sets of lights forming arrow patterns 804, 805, 806, 807 on either side of the lights comprising the warning pattern 802. The light array 801 may also have varying brightness levels that may he adjusted manually or automatically based on an ambient light sensor.

As shown in FIG. 1, the first step in the controller's operation. is to obtain host vehicle information 10. This vehicle information should include the speed as determined by the speed gauge, or other related devices such as a GPS, as well as the weight of the vehicle; if applicable, the load, including cargo or something being towed, such as a trailer, boat, camper, or additional vehicle; and the standard stopping distance of the host vehicle 105 at that weight and load under various weather and road conditions. The controller may have the option to automatically calculate and store braking characteristics of the host vehicle 105 under various load scenarios. Such a controller would automatically determine the deceleration rate of the host vehicle 105 during braking maneuvers and use the data in calculating the hazard zone 810 of the host vehicle 105, compensating for the longer stopping distance of the host vehicle 105 for heavier loads and other factors that would impact the host vehicle's braking ability. In certain embodiments, an operator of the host vehicle 105 may be able to access the controller to manually adjust the standard stopping distance to account for the age of the tires, brakes, or other equipment on the host vehicle 105 or other conditions relating to the operation of the host vehicle 105 that may impact the hazard zone 810.

The second step in the controller's operation is to obtain the host vehicle environmental information 20. In certain embodiments, the controller may be able to obtain environmental information from the host vehicle 105 relating to the road conditions the host vehicle 105 is experiencing. If a GPS is used as part of the controller, the GPS may provide further information regarding the grade of the road upon which the host vehicle 105 is traveling and local weather and traffic information. Additional environmental information may also be gathered through various means, such as through. a weather forecast station, temperature gauge, tire pressure gauge, operational status of windshield wipers, anemometer, inclinometer, and/or altimeter. Alternatively, the environmental information may he manually input directly from the operator of the host vehicle 105 or an affiliate to the operator who may he either local or remote or the operator might manually adjust the hazard zone 810. Should the affiliate be remote, the environmental information could be provided through a mobile data connection.

The third step in the controller's operation is to obtain proximate vehicle location information 30. This shall he accomplished through use of one or more proximity sensors 104, 106 to determine the distance between the host vehicle 105 and a proximate vehicle 107 and the vehicles' speeds as relative to each other. Until the controller receives information from the proximity sensor 104, it need not proceed to the next step, in some embodiments, the controller may be programmed to identify whether a proximate vehicle 107 is traveling in the same or opposite direction as compared to the host vehicle 105 such that a proximate vehicle 107 traveling in the opposite direction may be disregarded, in certain embodiments, the controller may be programmed to refrain from moving to the fourth step if the host vehicle 105 is operating at or below a certain speed.

The fourth step in the controller's operation is to calculate hazard zone 40 for the host vehicle 105. This hazard zone 40 calculation should take into account all information available to the controller and be based upon the ability of the host vehicle 105 to slow or stop should the proximate vehicle 107 slow or stop in front of the host vehicle 105 in the same lane.

The fifth step in the controller's operation is to control signal to proximate vehicle 50. If the controller determines the proximate vehicle 107 is traveling in the opposite direction and, thus, unlikely to move into the lane in front of the host vehicle 105, then the light array 801 should remain off or he set in an idle or standby mode. If the controller determines the proximate vehicle 107 may encroach the hazard zone 810 the host vehicle 105, then the controller may signal the proximate vehicle 107 through use of the light array 801 on the alert panel 101, turning on or flashing the lights of the light array 801 in a predetermined method. Once the controller determines the proximate vehicle 107 is far enough away from the host vehicle 105 to avoid the hazard zone 810 to the host vehicle 105, then the light array 801 will change in some way such as to flash, sequence, turn off, or turn a different color in order to indicate to the proximate vehicle 107 that the proximate vehicle 107 has passed the hazard zone 810. In some situations, the operator of the host vehicle 105 may opt, or the controller may be programmed, not to provide a signal that the proximate vehicle 107 has passed the hazard zone 810.

FIG. 2 depicts one embodiment of an alert panel 101 designed for placement on the exterior of the host vehicle 105. In the depicted embodiment, a light array 801 comprising a plurality of lights is shown. In certain embodiments, the alert panel 101 may comprise lights of different colors or different intensities to provide different indications to a proximate vehicle 107. In certain embodiments, such as is shown in. FIGS. 6-7, the light array 801 contains lights in a warning pattern 802, which is a set of lights forming an X shape in the center of the light array 801. This warning pattern 802 may be used by the controller to indicate that the proximate vehicle 107 is within the hazard zone 810 of the host vehicle 105. As depicted in FIG. 2, the light array 801 further contains additional sets of lights forming arrow patterns 804, 805, 806, 807 on either side of the lights comprising the warning pattern 802. When the proximate vehicle 107 has gained sufficient distance from the host vehicle 105 such that it is no longer within the hazard zone 810, the light array 801 may be lit in a different manner to indicate as much to the driver of the proximate vehicle 107. In an embodiment of the alert panel 101 as shown in FIGS. 9-10, a safety pattern 803, comprising one portion of the lights comprising the warning pattern 802 along with arrow patterns 806, 807, is illuminated to signal that the proximate vehicle 107 has passed the hazard zone 810 of the host vehicle 105. In certain embodiments, the alert panel 101 may be angled in such a way that it is only easily visible to the proximate vehicle 107 and it is not easily visible to other vehicles, such as, for example, a vehicle following the proximate vehicle 107, in certain embodiments, the alert panel 101 may be designed such that it will not reflect sunlight or ambient light in such a manner as to appear to be illuminated. In certain embodiments, an alert panel 101 may be located on the interior of the host vehicle 105. In certain embodiments, the host vehicle 105 may have more than one alert panel 101 such that they will be visible to a proximate vehicle 107 in a variety of positions, including in front of or to the left, right, or, in certain instances, the rear of the host vehicle 105. The logic of the controller would operate the plurality of alert panels 101 as appropriate such that the host vehicle 105 would not simultaneously signal more than one proximate vehicle 107 that it had moved past the hazard zone 810.

The traffic lane encroachment indicator system shall comprise at least one proximity sensor and optionally a plurality of proximity sensors. The alert panel 101 as depicted further comprises two proximity sensors 104, 106. In other embodiments, one or more proximity sensors may be positioned on the host vehicle 105 separately from the alert panel 101

FIG. 3 depicts an example of how the traffic lane encroachment indicator system may appear on a host vehicle 105 that is a semi-trailer truck. In the depicted embodiment, the alert panel 101 is located such that an operator of the proximate vehicle 107 is able to see the light array 801 in a rear-view mirror or sideview mirror of the proximate vehicle 107.

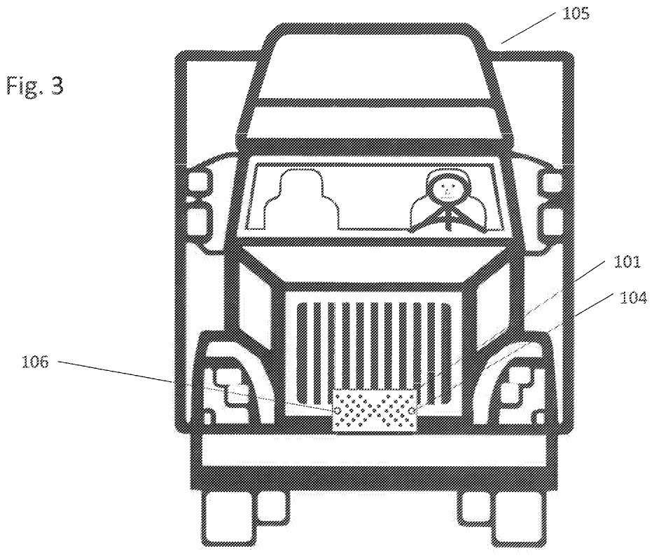

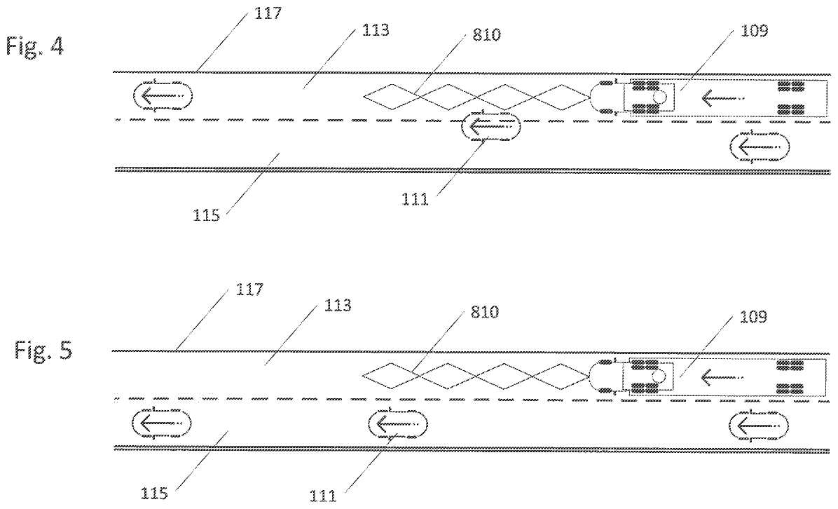

FIG. 4 depicts a semi-trailer truck 109 that does not have the lane encroachment indicator system. The truck 109 travels in the right lane 113 of the highway 117. A passing car 111 passes the truck 109 in the left lane 115. Since the truck 109 does not have the lane encroachment indicator system, the passing car 111 moves into the right lane 113 within the hazard zone 810 between itself and the truck 109, creating a potentially dangerous situation. should the passing car 111 have to slow down or stop.

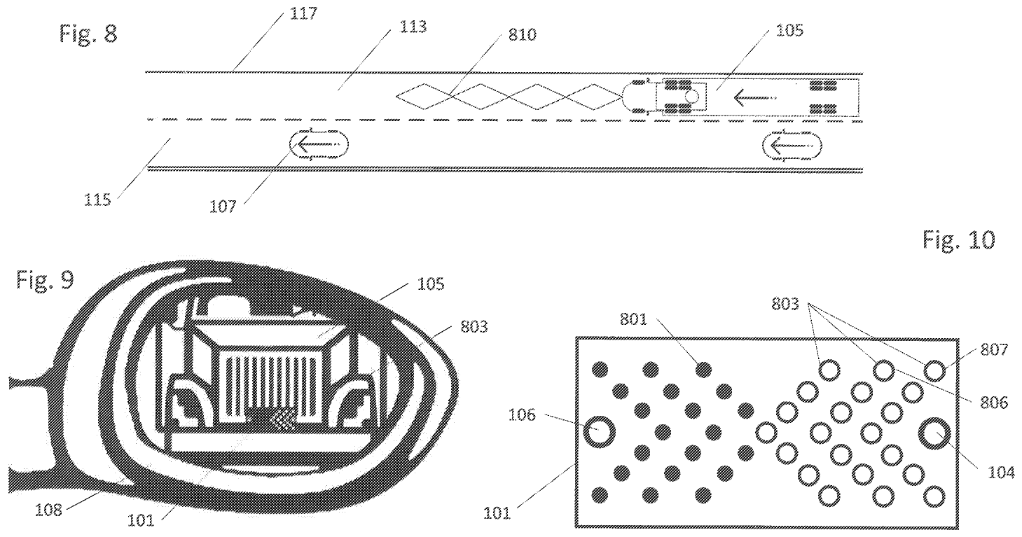

In FIGS. 5-10, on the other hand, the host vehicle 105 traveling in the right lane 113 of the highway 117 is equipped with an embodiment of the traffic lane encroachment indicator system. While the proximate vehicle 107 in the left lane 115 has not passed the hazard zone 810, the alert panel 101 indicates as much to the proximate vehicle 107 by controlling the light array 801 to display the warning pattern 802 as shown in FIGS. 6-7, such that the warning pattern 802 is visible in the sideview mirror 108 of the proximate vehicle 107. The warning pattern 802 may be illuminated fully, in a flashing pattern, or in a particular color, pattern, or intensity. When the proximate vehicle 107 gains sufficient distance as shown in FIG. 8 such that it is no longer in the hazard zone 810, the alert panel 101 may be illuminated to display a safety pattern 803, comprising one portion of the lights comprising the warning pattern 802 along with arrow patterns 806. 807. The safety pattern 803 indicates that the proximate vehicle 107 may more safely move into the right lane 113, and the operator of the proximate vehicle 107 is able to see this in the sideview mirror 108. The safety pattern 803 may be illuminated fully, in a flashing pattern, or in a particular color, pattern, or intensity.

Other embodiments of the lane encroachment indicator system may include additional features. In certain embodiments, a display is mounted within the host vehicle 105 such that it is visible to the operator and may provide updates regarding the controller's calculations and monitoring or other information relating to the lane encroachment indicator system or data gathered by the system. In other embodiments, the controller may provide audible reports to the operator of the host vehicle 105 regarding the controller's calculations and monitoring. In some embodiments, the controller may be able to provide the operator both audio and visual reports.

In some embodiments, the controller may be configured to send and/or receive information through mobile data or Bluetooth access. In certain of these embodiments, an affiliate of the operator of the host vehicle 105 may have the means to remotely send additional information, such as weather information or traffic reports, to the operator through the controller.

In certain of other embodiments, an affiliate of the operator of the host vehicle 105 may have the means to collect information regarding the operation of the host vehicle 105. In some embodiments, the controller may create and store records regarding certain operational activities relating to the host vehicle 105 including the date, time, and duration of such activities. This data may include, for example, whether the host vehicle 105 was operated in excess of the speed limit, whether the settings of the controller was manually adjusted, and other activities. In some embodiments, the controller may be programmed to determine whether the operator of the host vehicle 105 is following another vehicle too closely given the environmental conditions and the speed and condition of the host vehicle 105. Such calculations can be used to alert the operator and/or the operator's affiliate regarding the same.

In certain embodiments of the traffic lane encroachment indicator system, the system may further comprise one or more secondary visual proximity indicators and one or more secondary proximity sensors located in different places on the host vehicle. A secondary proximity sensor would determine the relative distance between the host vehicle 105 and a proximate vehicle 107 alongside or behind the host vehicle 105 and the vehicles' speeds as relative to each other. A secondary visual proximity indicator would alert a proximate vehicle 107 that it is passing too near alongside or following too closely behind the host vehicle 105.

In certain embodiments, two vehicles may each carry a traffic lane encroachment indicator system and such systems may be configured to communicate with each other. In such embodiments, one or both vehicles may have an audio or visual indicator to alert the vehicle operator that the hazard zone 810 in front of the following vehicle is encroached.

It is specifically anticipated that this traffic lane encroachment indicator system may be installed on a host vehicle during the process of the manufacture of the host vehicle or as an after-market accessory. It is further specifically acknowledged that the software of autonomous vehicles would have to be updated to incorporate recognition of the lane encroachment indicator system and its functionality. As the use of autonomous and semi-autonomous vehicles increases, the traffic lane encroachment indicator system may incorporate functionality to allow communications between such vehicles.

Those skilled in the art will recognize that modification and adaptions to the invention are possible without departing from the intended scope of the invention. Many variations and modifications may be affected within the spirit and scope of the invention as described in the appended claims. The components parts and steps of use described herein need not be performed in the order described, and component parts and steps may be added or omitted.

What is claimed is:

1. A traffic lane encroachment indicator system for a host vehicle comprising:
a. a means for determining the host vehicle's speed,
b. at least one proximity sensor on the host vehicle for detecting relative speed and proximity of a proximate vehicle,
c. at least one visual proximity indicator for signaling to the proximate vehicle of its encroachment of a hazard zone in front of the host vehicle, and
d. a controller for receiving information from the means for determining the host vehicle's speed and at least one proximity sensor, calculating distance between the host vehicle and the proximate vehicle, determining whether the proximate vehicle is within the hazard zone in front of the host vehicle, and operating the visual proximity indicator to signal the proximate vehicle it is within the hazard zone in front of the host vehicle.

2. The traffic lane encroachment indicator system as described in claim 1 further comprising visual proximity indicator for signaling to the proximate vehicle it is not within the hazard zone in front of the host vehicle.

3. The traffic lane encroachment indicator system as described in claim 1 wherein the means for determining the host vehicle's speed is selected from the group consisting essentially of one or more of a UPS, a speedometer located within the host vehicle, or a smartphone communicating with the controller and capable of providing the host vehicle's speed.

4. The traffic lane encroachment indicator system as described in claim 1 further comprising:
a. at least one environmental information source for gathering additional information regarding conditions impacting the host vehicle, and
b. the controller capable of receiving information from the at least one environmental information source and incorporating the additional information in determining the minimum passing distance.

5. The traffic lane encroachment indicator system as described in claim 4 wherein the at least one environmental information source is selected from the group consisting essentially of one or more of a weather forecast station, a temperature gauge, a tire pressure gauge, operational status of windshield wipers, an anemometer, an inclinometer, an altimeter, and combinations thereof.

6. The traffic lane encroachment indicator system as described in claim 1 wherein the at least one proximity sensor is selected from the group consisting essentially of camera, radar, lidar, ultrasound, and combinations thereof.

7. The traffic lane encroachment indicator system as described in claim 1 wherein the at least one visual proximity indicator is configured to turn off and on.

8. The traffic lane encroachment indicator system as described in claim 7 wherein the at least one visual proximity indicator is configured to flash, change color, display a preselected pattern, or a combination thereof.

9. The traffic lane encroachment indicator system as described in claim 1 further comprising a means for an operator of the host vehicle to provide additional input to the controller wherein such additional input is selected from the group consisting essentially of manually modifying the minimum passing distance, inputting additional data for determining whether the proximate vehicle is within the hazard zone in front of the host vehicle, placing the traffic lane encroachment indicator system in standby mode, turning off the traffic lane encroachment indicator system, and combinations thereof.

10. The traffic lane encroachment indicator system as described in claim 1 further comprising a means for inputting weight of the host vehicle into the controller and wherein the controller is capable of incorporating the weight in determining the hazard zone of the host vehicle.

11. The traffic lane encroachment indicator system as described in claim 1 wherein the controller is configured to store and send to a third-party system information relating to operation of the host vehicle.

12. The traffic lane encroachment indicator system as described in claim 4 wherein the controller is configured to receive information regarding conditions impacting the host vehicle from a third-party system, store the information received, and incorporate the information received in determining the hazard zone.

13. The traffic lane encroachment indicator system as described in claim 1 wherein the controller is configured to refrain from use of the at least one visual proximity indicator when the host vehicle is operating below a particular speed.

14. The traffic lane encroachment indicator system as described in claim 1 wherein the at least one proximity sensor on the host vehicle is configured to determine whether the proximate vehicle is oncoming rather than traveling in the same direction, and the controller is capable of maintaining the at least one proximity sensor in the off position.

15. The traffic lane encroachment indicator system as described in claim 1 further comprising an operator alert indicator within the host vehicle, and wherein the controller is capable of operating the operator alert indicator to warn an operator of the host vehicle that the proximate vehicle has not achieved the minimum passing distance.

16. The traffic lane encroachment indicator system as described in claim 15 wherein the operator alert indicator is selected from the group consisting essentially of an audio indicator, a visual indicator, and a combination thereof.

17. A traffic lane encroachment indicator system for a host vehicle comprising:
a. a speed gauge for determining the host vehicle's speed,
b. at least one proximity sensor on the host vehicle for detecting relative speed and proximity of a proximate vehicle,
c. at least one visual proximity indicator for signaling to the proximate vehicle of its encroachment of a hazard zone in front of the host vehicle,
d. an operator alert indicator within the host vehicle for providing information to an operator of the host vehicle,
e. a controller for receiving information from the speed gauge and proximity sensor, calculating distance between the host vehicle and the proximate vehicle, determining whether the proximate vehicle is within the hazard zone in front of the host vehicle, operating the visual proximity indicator to signal the proximate vehicle it is within the hazard zone, and operating the operator alert indicator to signal the operator of the host vehicle that the proximate vehicle it is within the hazard zone.

18. The traffic lane encroachment indicator system as described in claim 17 wherein the controller is configured to determine whether the operator of the host vehicle reacted to operation of the operator alert indicator and to store information regarding how the operator reacted.

19. The traffic lane encroachment indicator system as described in claim 18 wherein the controller is configured to store and send information to a third-party regarding determination of whether the operator of the host vehicle reacted to operation of the operator alert indicator and information regarding how the operator reacted.

20. A traffic lane encroachment indicator system for a host vehicle comprising:
a. a means for determining the host vehicle's speed,
b. at least one primary proximity sensor on the host vehicle for detecting relative speed and proximity of a proximate vehicle that is ahead of the host vehicle and moving in the same direction,
c. at least one secondary proximity sensor on the host vehicle for detecting relative speed and proximity of a proximate vehicle that is alongside or behind the host vehicle and moving in the same direction,
d. at least one primary visual. proximity indicator for signaling to the proximate vehicle of its encroachment of a hazard zone in front of the host vehicle,
e. at least one secondary visual proximity indicator for signaling to the proximate vehicle of its encroachment of a hazard zone alongside or behind the host vehicle, and
f. a controller for:
i. receiving information from the means for determining the host vehicle's speed, the at least one primary proximity sensor, and the at least one secondary proximity sensor,
ii. calculating distance between the host vehicle and the proximate vehicle,
iii. determining whether the proximate vehicle is within the hazard zone in front of, alongside, or behind the host vehicle,
iv. operating at least one primary visual proximity indicator to signal the proximate vehicle it is within the hazard zone in front of the host vehicle, and
v. operating at least one secondary visual proximity indicator to signal the proximate vehicle it is within the hazard zone alongside or behind the host vehicle.
